(19) United States
(12) Patent Application Publication
(10) Pub. No.: US 2023/0185603 A1
(43) Pub. Date: Jun. 15, 2023

(54) DYNAMIC CAPABILITY DISCOVERY AND ENFORCEMENT FOR ACCELERATORS AND DEVICES IN MULTI-TENANT SYSTEMS

(71) Applicant: Intel Corporation, Santa Clara, CA (US)

(72) Inventors: Saurabh Gayen, Portland, OR (US); Philip Lantz, Cornelius, OR (US); Narayan Ranganathan, Bangalore (IN); Dhananjay Joshi, Portland, OR (US); Rajesh Sankaran, Portland, OR (US); Utkarsh Kakaiya, Folsom, CA (US)

(73) Assignee: Intel Corporation, Santa Clara, CA (US)

(21) Appl. No.: 17/551,166

(22) Filed: Dec. 14, 2021

(51) Int. Cl. G06F 9/48; G06Q 30/02

(52) U.S. Cl. CPC G06F 9/4881; G06Q 30/0283

(57) ABSTRACT

Methods and apparatus relating to dynamic capability discovery and enforcement for accelerators and devices in multi-tenant systems are described. In an embodiment, a hardware accelerator device advertises one or more available operations and/or capabilities of the hardware accelerator device to one or more tenants. Logic circuitry controls access to the one or more available operations and/or capabilities of the one or more work queues on a per-tenant basis. Other embodiments are also disclosed and claimed.

### FIELD

The present disclosure generally relates to the field of computing systems. More particularly, an embodiment relates to dynamic capability discovery and enforcement for accelerators and devices in multi-tenant systems.

### BACKGROUND

Multi-tenant systems are quickly gaining popularity. A multi-tenant system allows multiple users to share a single hardware accelerator or device. A tenant can be an individual user, but may also include a group of users, such as a customer organization—that shares common access to and privileges to the hardware accelerator or device.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a system that provides per Work Queue (WQ) capability confirmation, according to an embodiment.

FIG. 2 illustrates a block diagram of a system that provides per WQ capability enforcement, according to an embodiment.

FIG. 3 illustrates a block diagram of a system to provide price differentiation for Virtual Machines (VMs) on the same device, according to an embodiment.

FIG. 4 illustrates a block diagram for VM migration across different generation devices, according to an embodiment.

FIG. 5 illustrates a block diagram of a system to provide per-WQ system resource availability, according to an embodiment.

FIG. 6A is a block diagram illustrating both an exemplary in-order pipeline and an exemplary register renaming, out-of-order issue/execution pipeline according to embodiments.

FIG. 6B is a block diagram illustrating both an exemplary embodiment of an in-order architecture core and an exemplary register renaming, out-of-order issue/execution architecture core to be included in a processor according to embodiments.

FIG. 7 illustrates a block diagram of an SOC (System On Chip) package in accordance with an embodiment.

FIG. 8 is a block diagram of a processing system, according to an embodiment.

FIG. 9 is a block diagram of an embodiment of a processor having one or more processor cores, according to some embodiments.

FIG. 10 is a block diagram of a graphics processor, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, a multi-tenant system allows multiple users to share a single hardware accelerator or device. In multi-tenant systems, multiple VMs (Virtual Machines), containers, and/or applications may share the same hardware accelerator or device. Technology exists today to enable these tenants to use the same shared accelerator. New usage models can be enabled if a device driver has the ability to advertise different acceleration operations and other capabilities on a per-tenant basis (or per-tenant-class basis) for the same device. The device driver would require the device hardware to be able to enforce usage on a per-tenant basis as different tenants would have different capabilities advertised.

To this end, some embodiments provide one or more techniques for dynamic capability discovery and enforcement for accelerators and devices in multi-tenant systems. In an embodiment, an architecture is disclosed where the device driver is able to configure a device to advertise different capabilities on a per-tenant basis, and then rely on the device hardware's ability to enforce those capabilities on a per-tenant basis. As discussed herein, “per-tenant” may be used as a proxy for “per-tenant or per-tenant class.” This is to reflect that some embodiments encompass job submission portals, such as Dedicated Work Queues (DWQs) that have a single unique Process Address Space Identifier (PASID) for a tenant they can accommodate, as well as Shared Work Queues (SWQs) that can support multiple PASIDs.

Moreover, a Central Processing Unit Identification (CPUID) instruction may be used by software to obtain processor identification and information about various features supported by a CPU or processor. This includes information about hardware resources such as caches and Translation Look-aside Buffers (TLBs), power management and Resource Director Technology (RDT) capabilities, CPU instructions and instruction classes such as Streaming SIMD (Single Instruction, Multiple Data) Extension (SSE) and Advanced Vector Extension (AVX), and various other CPU features including ones for security and virtualization. The CPUID instruction uses a request-response model to return the necessary feature enumeration. Software specifies the CPUID instruction with appropriate input values to enumerate the desired portion of the feature hierarchy. The values returned by the CPU may be used to identify the feature classes and additional details pertaining to the requested features. The CPUID architecture itself, however, fails to provide the ability to control or constrain features usable by software or on a per-tenant basis.

Further, the Data Streaming Accelerator (DSA) generation one (Gen1) architecture (Intel® DSA, provided by Intel Corporation of Santa Clara, Calif., November 2019) has a feature that allows the device driver to restrict the maximum payload size and maximum batch size on a per-tenant basis. The DSA also has a feature that allows Address Translation Services (ATS) to be disabled on a per-tenant basis. The DSA Gen1 architecture, however, fails to provide the ability to enumerate and enforce operations on a per-tenant basis. The DSA is focused on using work size limitations to ensure device-level performance and Quality of Service (QoS), as well as avoiding ATS related performance problems.

Additionally, Smart Data Accelerator Interface (SDXI) is another existing accelerator architecture. The SDXI has the ability to expose different Virtual Functions (VFs) with differentiated capabilities. VMs or other tenants may be mapped to specific VFs, while VMMs have the ability to control which capabilities each VF exposes. SDXI is one example of a Single Root I/O (Input/Output) Virtualization (SR-IOV)) device architecture that can have per-VF capabilities that can be configured and enforced. However, SDXI can only differentiate capabilities on a per-function basis, not on a per-tenant basis within a function such as provided per at least one embodiment. This difference significantly limits the scalability aspect of SDXI as the number of tenants scales beyond what multiple VFs can support.

By contrast, at least one embodiment allows a device driver to configure different work submission portals called WQs (Work Queues) to advertise different operations and/or capabilities for different tenants. Tenants (e.g., VMs, containers, applications, etc.) mapped to different WQs may discover per-WQ operations and/or capabilities and, for example, will only be able to submit operations that have been advertised for their particular WQ. Device hardware enforces per-WQ advertised capabilities to make sure that tenants are unable to bypass the restrictions imposed on them in an embodiment. Also, one embodiment provides differentiated operations and/or capabilities on a per-tenant basis, enabling multiple new usage models where different tenants can be advertised as supporting different (e.g., acceleration) operations and/or capabilities.

Some advantages of one or more embodiments include one or more of:

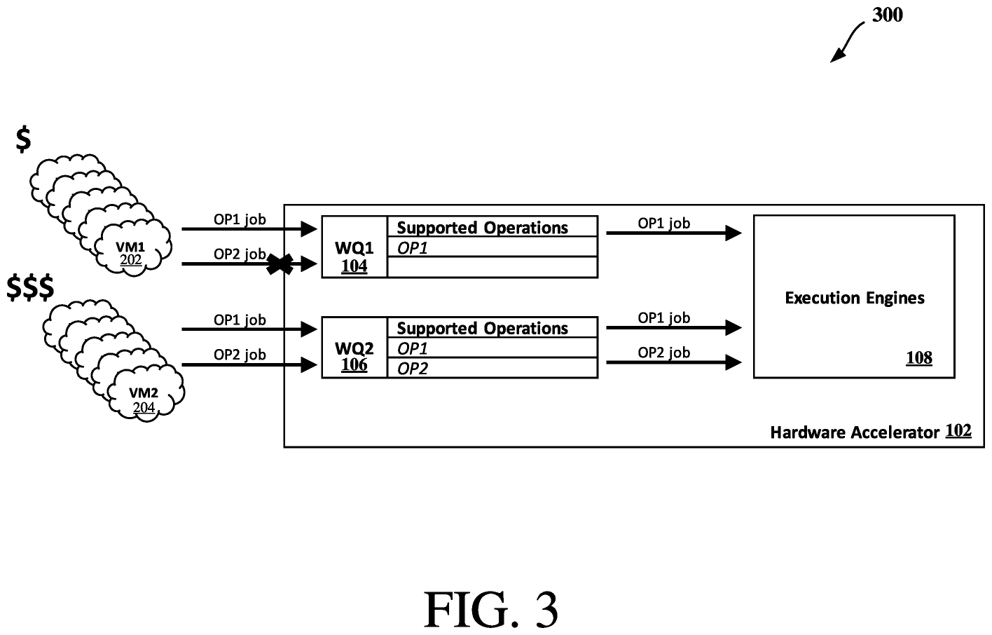

(1) Price differentiation: CSPs (Cloud Service Providers) can have differentiated pricing for different customers based on the operations and/or other capabilities enabled for each customer, even when different customers are sharing the same device(s) (see, e.g., FIG. 3).

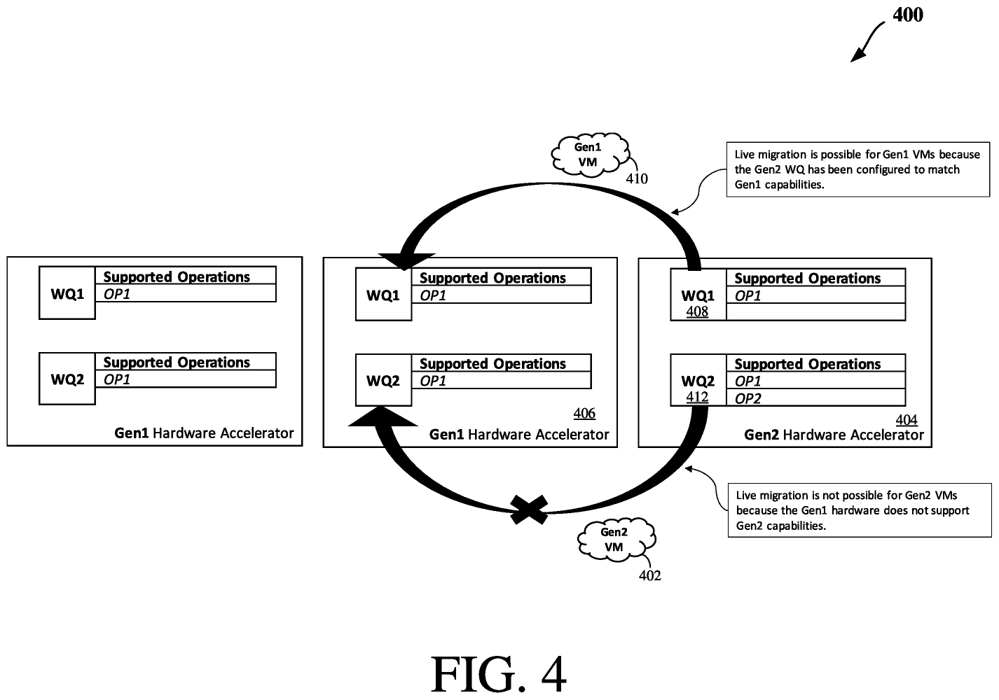

(2) Live migration compatibility: CSPs can have a live migration friendly set of nodes by purposely/dynamically downgrading capabilities advertised to targeted VMs on advanced capability later generation device(s) (see, e.g., FIG. 4).

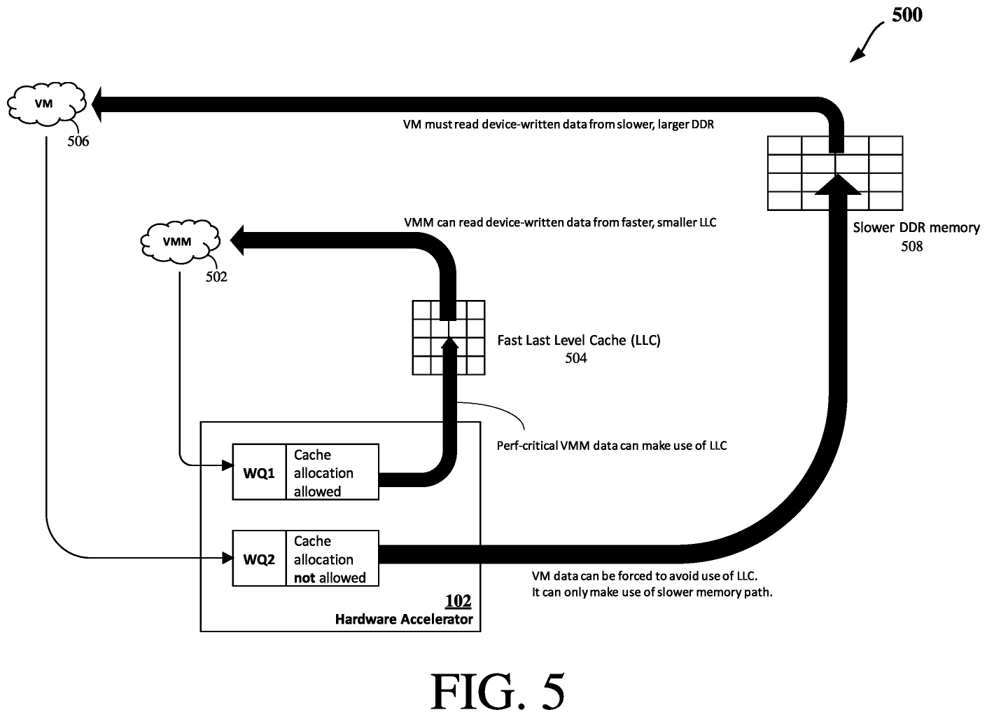

(3) Cache pollution avoidance: VMM (VM manager) can prevent VMs from impacting host Operating System (OS) performance by preventing VMs from allocating to LLC (Last Level Cache) even while the host OS's own jobs are allowed to make use of this limited SoC resource (see, e.g., FIG. 5).

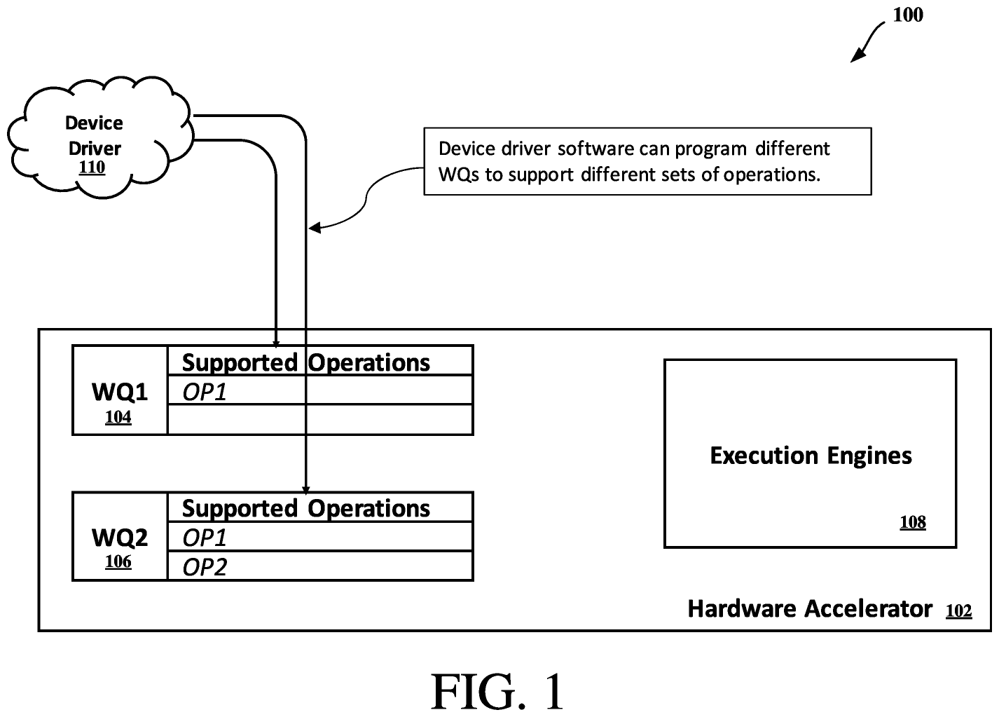

FIG. 1 illustrates a block diagram of a system 100 that provides per Work Queue (WQ) capability confirmation, according to an embodiment. Generally, a device (of which hardware accelerator 102 is an example) may support a mechanism to submit jobs or descriptors to it. When a device is shared among multiple tenants (e.g., VMs, containers, applications, etc.), then virtualization can be used to allow each tenant to use the device without worrying about other tenants sharing the same device. In this disclosure, Work Queues (WQs) are used as the job submission mechanism to illustrate various embodiments, but other mechanisms may take advantage of the embodiments as well. Once descriptors are submitted to WQs 104/106, the device can execute them using Execution Engine(s) 108 that can come in different forms for different devices.

WQs may operate by having a particular MMIO (Memory Mapped I/O) address(es) mapped to one or more tenants. Other tenants do not have the WQ mapped to them, so the WQ acts as a per-tenant or per-tenant-class portal that excluded tenants are unable to access. In an embodiment, operations and/or other capabilities are advertised on a per-device basis, and all tenants on the device are informed about which operations a particular device supports, so that the tenants are aware that they can only submit those operations to a given device. In one embodiment, operations and/or other capabilities are advertised on a per-WQ basis rather than on a per-device basis.

As shown in example usage FIG. 1, the device driver 110 is able to program WQ1 104 to allow only operation OP1, while it can program WQ2 106 to allow both operations OP1 and OP2. This configuration may be done through registers (not shown) that only the device driver 110 can read and write to. VMs can later ask the device driver 110 to query these registers to learn which operations and/or capabilities are available for the VM to submit. In this case, VMs mapped to WQ1 104 would learn that they are only allowed to submit OP1 descriptors, while VMs mapped to WQ2 106 would learn that they are allowed to submit both OP1 and OP2 descriptors.

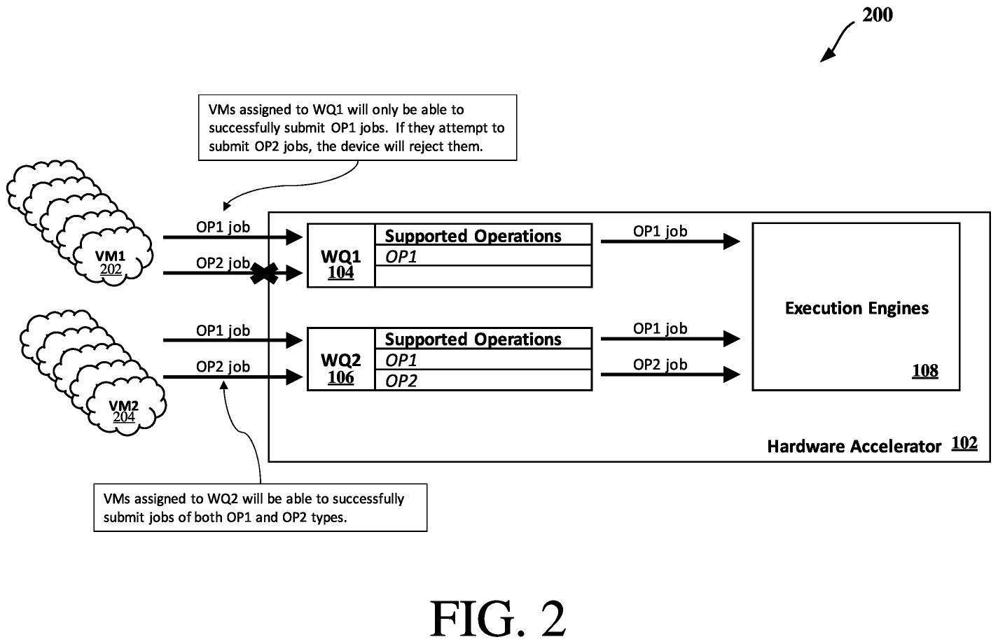

VMs may not follow the advertised per-WQ operations and capabilities, and FIG. 2 shows what happens in this case. More particularly, FIG. 2 illustrates a block diagram of a system 200 that provides per WQ capability enforcement, according to an embodiment. If VM1 202 ignores the advertised restrictions and sends OP2 descriptors anyway, the hardware accelerator device 102 will enforce the per-WQ restriction and reject those descriptors submitted to WQ1 104. The hardware accelerator device 102 will accept OP1 descriptors from VM1 202 as that operation was advertised to be allowed for this WQ. On the other hand, VM2 204 can submit both OP1 and OP2 descriptors and both would be accepted by WQ2 106, which is the WQ that VM2 204 is mapped to. Only accepted WQs are executed by Execution Engine(s) 108 on the device 102.

FIG. 3 illustrates a block diagram of a system 300 to provide price differentiation for Virtual Machines (VMs) on the same device, according to an embodiment. One example application is to allow differentiated pricing for different VMs sharing the same device 102. FIG. 3 shows how VM1 202 could be charged a lower price by the CSP because it is only allowed to run OP1 descriptors, while VM2 204 could be charged a higher price because it is allowed to run both OP1 and OP2 descriptors.

FIG. 4 illustrates a block diagram 400 for VM migration across different generation devices, according to an embodiment. Moreover, another example application is to help manage a datacenter of nodes that instantiate a mix of generations of the device. As shown in FIG. 4, a particular VM 402 may be running on a Gen2 device 404, but the datacenter manager may want to have the ability to subsequently migrate that VM smoothly to a Gen1 device 406. In this case, OP2 is an operation that was added as a generational improvement in Gen2 devices, and Gen1 devices do not have the ability to execute OP2 descriptors. To achieve standardization, a datacenter manager can configure a WQ on the Gen2 device to only allow operations and capabilities that are available with Gen1, i.e., only OP1 in this example for WQ1 408.

FIG. 4 shows how VM 410 can be smoothly migrated from a Gen2 device 404 to a Gen1 device 406 because both current and target WQs only advertise OP1. On the other hand, VM 402 cannot be smoothly migrated because Gen2 device WQ2 412 was advertising both OP1 and OP2 and the Gen1 device 406 cannot support Gen2 OP2 operations. Conversely, if VM 410 were to later be migrated back to a Gen2 device 404, the WQ on the Gen2 device should be configured using an embodiment to only support Gen1 operations, i.e., OP1 but not OP2. This ensures that the VM can freely be migrated as many times as desired between devices of different generations.

FIG. 5 illustrates a block diagram of a system 500 to provide per-WQ system resource availability, according to an embodiment. Yet another example application is to provide varying levels of system resources and/or QoS (Quality of Service) to tenants mapped to different WQs on the same device. For example, caching resources (e.g., LLC or Last Level Cache 504) on the chip are limited resources that can help improve workload performance. However, a VMM 502 may choose to only allow LLC caching for its own uses, while preventing VMs 506 from making use of the LLC 504; thus, ensuring that lower priority VM usage does not cause cache pollution and other impacts to its own usage of LLC 504. The VMM 502 can also allow a VM on one WQ to cache to LLC while a VM on a different WQ would not be able to, e.g., if it wants to provide higher system resource availability and/or QoS for only certain VMs on the same device. In this example and diagram, DDR 508 is a resource that VMs are forced to use as a lower performance resource, because they are prevented from using the higher performance LLC 504. Also, VMs that are excluded from using LLC can instead write to DDR, and they are prevented from benefiting from LLC performance. Moreover, FIG. 5 shows how WQ restrictions can ensure that VMs on a device are forced to avoid using the LLC 504; thus, restricting/controlling access to this limited system resource.

Additionally, some embodiments may be applied in computing systems that include one or more processors (e.g., where the one or more processors may include one or more processor cores), such as those discussed with reference to FIGS. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU (Central Processing Unit) including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

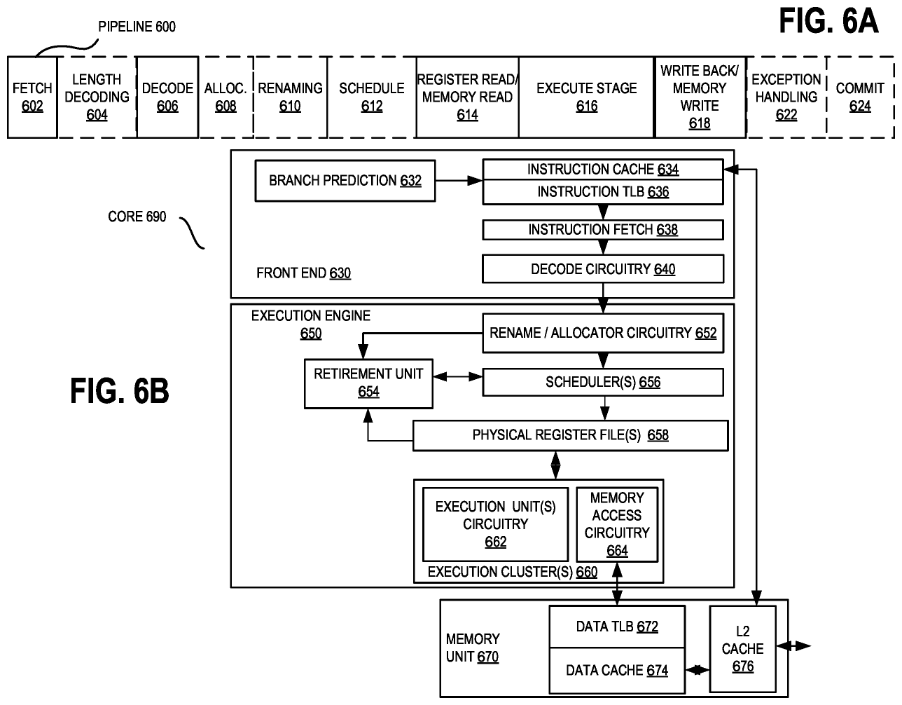

FIG. 6A is a block diagram illustrating both an exemplary in-order pipeline and an exemplary register renaming, out-of-order issue/execution pipeline according to embodiments. FIG. 6B is a block diagram illustrating both an exemplary embodiment of an in-order architecture core and an exemplary register renaming, out-of-order issue/execution architecture core to be included in a processor according to embodiments. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624.

FIG. 6B shows processor core 690 including a front end unit 630 coupled to an execution engine unit 650, and both are coupled to a memory unit 670. The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front end unit 630 includes a branch prediction unit 632 coupled to an instruction cache unit 634, which is coupled to an instruction translation lookaside buffer (TLB) 636, which is coupled to an instruction fetch unit 638, which is coupled to a decode unit 640. The decode unit 640 (or decoder) may decode instructions, and generate as an output one or more micro-operations, micro-code entry points, microinstructions, other instructions, or other control signals, which are decoded from, or which otherwise reflect, or are derived from, the original instructions. The decode unit 640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 690 includes a microcode ROM or other medium that stores microcode for certain macroinstructions (e.g., in decode unit 640 or otherwise within the front end unit 630). The decode unit 640 is coupled to a rename/allocator unit 652 in the execution engine unit 650.

The execution engine unit 650 includes the rename/allocator unit 652 coupled to a retirement unit 654 and a set of one or more scheduler unit(s) 656. The scheduler unit(s) 656 represents any number of different schedulers, including reservations stations, central instruction window, etc. The scheduler unit(s) 656 is coupled to the physical register file(s) unit(s) 658. Each of the physical register file(s) units 658 represents one or more physical register files, different ones of which store one or more different data types, such as scalar integer, scalar floating point, packed integer, packed floating point, vector integer, vector floating point status (e.g., an instruction pointer that is the address of the next instruction to be executed), etc. In one embodiment, the physical register file(s) unit 658 comprises a vector registers unit, a writemask registers unit, and a scalar registers unit. These register units may provide architectural vector registers, vector mask registers, and general purpose registers. The physical register file(s) unit(s) 658 is overlapped by the retirement unit 654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 654 and the physical register file(s) unit(s) 658 are coupled to the execution cluster(s) 660. The execution cluster(s) 660 includes a set of one or more execution units 662 and a set of one or more memory access units 664. The execution units 662 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 656, physical register file(s) unit(s) 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 664). It should also be understood that where separate pipelines are used, one or more of these pipelines may be out-of-order issue/execution and the rest in-order.

The set of memory access units 664 is coupled to the memory unit 670, which includes a data TLB unit 672 coupled to a data cache unit 674 coupled to a level 2 (L2) cache unit 676. In one exemplary embodiment, the memory access units 664 may include a load unit, a store address unit, and a store data unit, each of which is coupled to the data TLB unit 672 in the memory unit 670. The instruction cache unit 634 is further coupled to a level 2 (L2) cache unit 676 in the memory unit 670. The L2 cache unit 676 is coupled to one or more other levels of cache and eventually to a main memory.

By way of example, the exemplary register renaming, out-of-order issue/execution core architecture may implement the pipeline 600 as follows: 1) the instruction fetch 638 performs the fetch and length decoding stages 602 and 604; 2) the decode unit 640 performs the decode stage 606; 3) the rename/allocator unit 652 performs the allocation stage 608 and renaming stage 610; 4) the scheduler unit(s) 656 performs the schedule stage 612; 5) the physical register file(s) unit(s) 658 and the memory unit 670 perform the register read/memory read stage 614; the execution cluster 660 perform the execute stage 616; 6) the memory unit 670 and the physical register file(s) unit(s) 658 perform the write back/memory write stage 618; 6) various units may be involved in the exception handling stage 622; and 8) the retirement unit 654 and the physical register file(s) unit(s) 658 perform the commit stage 624.

The core 690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 690 includes logic to support a packed data instruction set extension (e.g., AVX1, AVX2), thereby allowing the operations used by many multimedia applications to be performed using packed data.

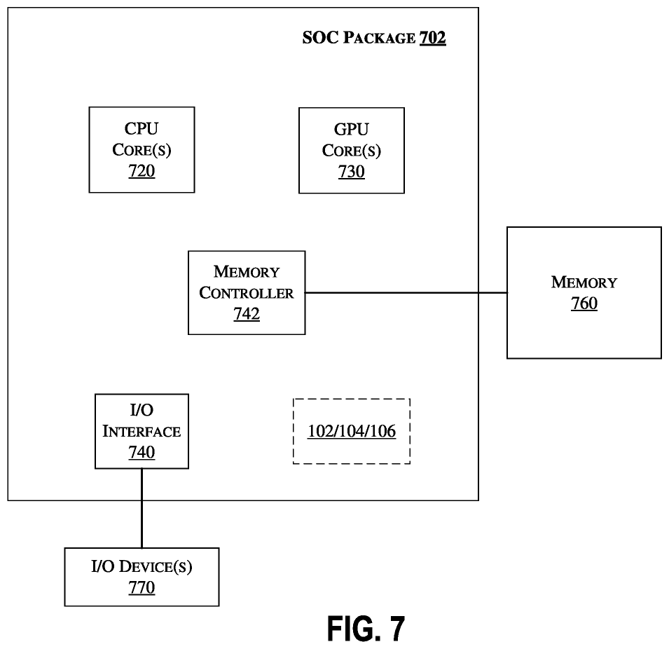

FIG. 7 illustrates a block diagram of an SOC package in accordance with an embodiment. As illustrated in FIG. 7, SOC 702 includes one or more Central Processing Unit (CPU) cores 720, one or more Graphics Processor Unit (GPU) cores 730, an Input/Output (I/O) interface 740, and a memory controller 742. Various components of the SOC package 702 may be coupled to an interconnect or bus such as discussed herein with reference to the other figures. Also, the SOC package 702 may include more or less components, such as those discussed herein with reference to the other figures. Further, each component of the SOC package 702 may include one or more other components, e.g., as discussed with reference to the other figures herein. In one embodiment, SOC package 702 (and its components) is provided on one or more Integrated Circuit (IC) die, e.g., which are packaged into a single semiconductor device.

As illustrated in FIG. 7, SOC package 702 is coupled to a memory 760 via the memory controller 742. In an embodiment, the memory 760 (or a portion of it) can be integrated on the SOC package 702.

The I/O interface 740 may be coupled to one or more I/O devices 770, e.g., via an interconnect and/or bus such as discussed herein with reference to other figures. I/O device(s) 770 may include one or more of a keyboard, a mouse, a touchpad, a display, an image/video capture device (such as a camera or camcorder/video recorder), a touch screen, a speaker, or the like.

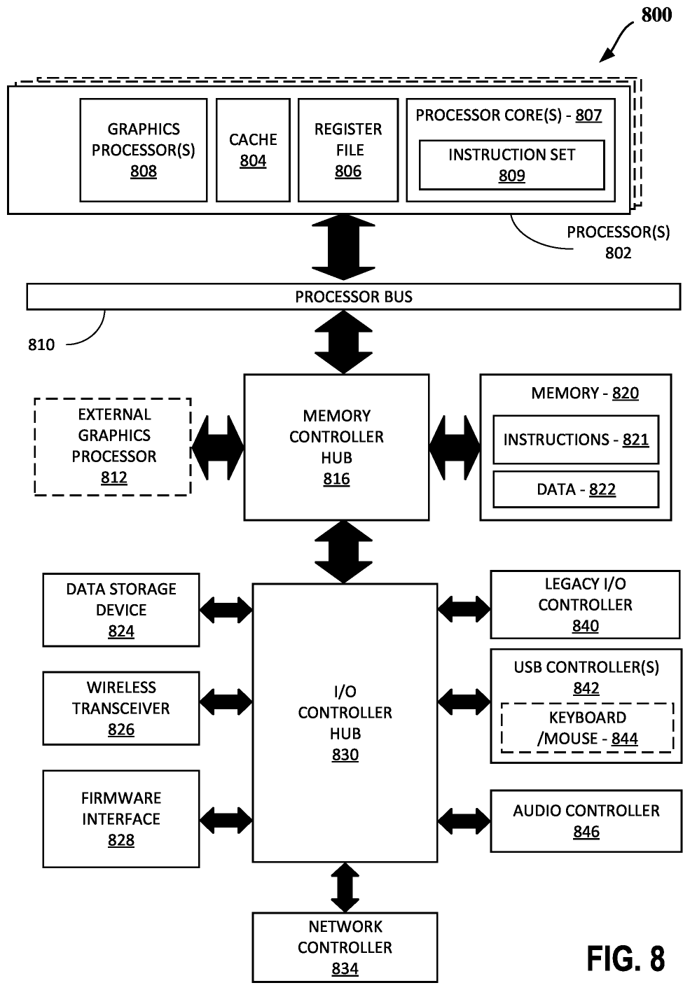

FIG. 8 is a block diagram of a processing system 800, according to an embodiment. In various embodiments the system 800 includes one or more processors 802 and one or more graphics processors 808, and may be a single processor desktop system, a multiprocessor workstation system, or a server system having a large number of processors 802 or processor cores 807. In on embodiment, the system 800 is a processing platform incorporated within a system-on-a-chip (SoC or SOC) integrated circuit for use in mobile, handheld, or embedded devices.

An embodiment of system 800 can include, or be incorporated within a server-based gaming platform, a game console, including a game and media console, a mobile gaming console, a handheld game console, or an online game console. In some embodiments system 800 is a mobile phone, smart phone, tablet computing device or mobile Internet device. Data processing system 800 can also include, couple with, or be integrated within a wearable device, such as a smart watch wearable device, smart eyewear device, augmented reality device, or virtual reality device. In some embodiments, data processing system 800 is a television or set top box device having one or more processors 802 and a graphical interface generated by one or more graphics processors 808.

In some embodiments, the one or more processors 802 each include one or more processor cores 807 to process instructions which, when executed, perform operations for system and user software. In some embodiments, each of the one or more processor cores 807 is configured to process a specific instruction set 809. In some embodiments, instruction set 809 may facilitate Complex Instruction Set Computing (CISC), Reduced Instruction Set Computing (RISC), or computing via a Very Long Instruction Word (VLIW). Multiple processor cores 807 may each process a different instruction set 809, which may include instructions to facilitate the emulation of other instruction sets. Processor core 807 may also include other processing devices, such a Digital Signal Processor (DSP).

In some embodiments, the processor 802 includes cache memory 804. Depending on the architecture, the processor 802 can have a single internal cache or multiple levels of internal cache. In some embodiments, the cache memory is shared among various components of the processor 802. In some embodiments, the processor 802 also uses an external cache (e.g., a Level-3 (L3) cache or Last Level Cache (LLC)) (not shown), which may be shared among processor cores 807 using known cache coherency techniques. A register file 806 is additionally included in processor 802 which may include different types of registers for storing different types of data (e.g., integer registers, floating point registers, status registers, and an instruction pointer register). Some registers may be general-purpose registers, while other registers may be specific to the design of the processor 802.

In some embodiments, processor 802 is coupled to a processor bus 810 to transmit communication signals such as address, data, or control signals between processor 802 and other components in system 800. In one embodiment the system 800 uses an exemplary ‘hub’ system architecture, including a memory controller hub 816 and an Input Output (I/O) controller hub 830. A memory controller hub 816 facilitates communication between a memory device and other components of system 800, while an I/O Controller Hub (ICH) 830 provides connections to I/O devices via a local I/O bus. In one embodiment, the logic of the memory controller hub 816 is integrated within the processor.

Memory device 820 can be a dynamic random access memory (DRAM) device, a static random access memory (SRAM) device, flash memory device, phase-change memory device, or some other memory device having suitable performance to serve as process memory. In one embodiment the memory device 820 can operate as system memory for the system 800, to store data 822 and instructions 821 for use when the one or more processors 802 executes an application or process. Memory controller hub 816 also couples with an optional external graphics processor 812, which may communicate with the one or more graphics processors 808 in processors 802 to perform graphics and media operations.

In some embodiments, ICH 830 enables peripherals to connect to memory device 820 and processor 802 via a high-speed I/O bus. The I/O peripherals include, but are not limited to, an audio controller 846, a firmware interface 828, a wireless transceiver 826 (e.g., Wi-Fi, Bluetooth), a data storage device 824 (e.g., hard disk drive, flash memory, etc.), and a legacy I/O controller 840 for coupling legacy (e.g., Personal System 2 (PS/2)) devices to the system. One or more Universal Serial Bus (USB) controllers 842 connect input devices, such as keyboard and mouse 844 combinations. A network controller 834 may also couple to ICH 830. In some embodiments, a high-performance network controller (not shown) couples to processor bus 810. It will be appreciated that the system 800 shown is exemplary and not limiting, as other types of data processing systems that are differently configured may also be used. For example, the I/O controller hub 830 may be integrated within the one or more processor 802, or the memory controller hub 816 and I/O controller hub 830 may be integrated into a discreet external graphics processor, such as the external graphics processor 812.

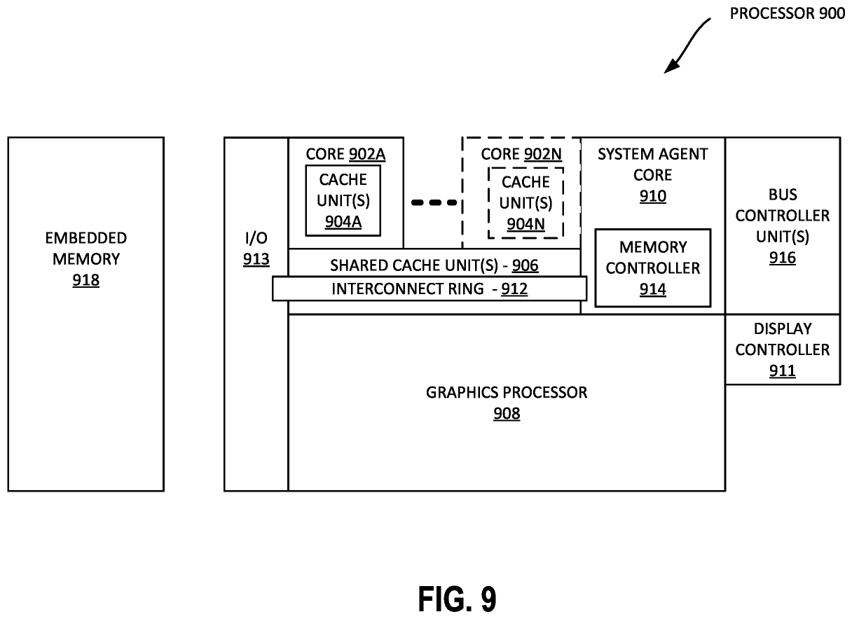

FIG. 9 is a block diagram of an embodiment of a processor 900 having one or more processor cores 902A to 902N, an integrated memory controller 914, and an integrated graphics processor 908. Those elements of FIG. 9 having the same reference numbers (or names) as the elements of any other figure herein can operate or function in any manner similar to that described elsewhere herein, but are not limited to such. Processor 900 can include additional cores up to and including additional core 902N represented by the dashed lined boxes. Each of processor cores 902A to 902N includes one or more internal cache units 904A to 904N. In some embodiments each processor core also has access to one or more shared cached units 906.

The internal cache units 904A to 904N and shared cache units 906 represent a cache memory hierarchy within the processor 900. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 906 and 904A to 904N.

In some embodiments, processor 900 may also include a set of one or more bus controller units 916 and a system agent core 910. The one or more bus controller units 916 manage a set of peripheral buses, such as one or more Peripheral Component Interconnect buses (e.g., PCI, PCI Express). System agent core 910 provides management functionality for the various processor components. In some embodiments, system agent core 910 includes one or more integrated memory controllers 914 to manage access to various external memory devices (not shown).

In some embodiments, one or more of the processor cores 902A to 902N include support for simultaneous multi-threading. In such embodiment, the system agent core 910 includes components for coordinating and operating cores 902A to 902N during multi-threaded processing. System agent core 910 may additionally include a power control unit (PCU), which includes logic and components to regulate the power state of processor cores 902A to 902N and graphics processor 908.

In some embodiments, processor 900 additionally includes graphics processor 908 to execute graphics processing operations. In some embodiments, the graphics processor 908 couples with the set of shared cache units 906, and the system agent core 910, including the one or more integrated memory controllers 914. In some embodiments, a display controller 911 is coupled with the graphics processor 908 to drive graphics processor output to one or more coupled displays. In some embodiments, display controller 911 may be a separate module coupled with the graphics processor via at least one interconnect, or may be integrated within the graphics processor 908 or system agent core 910.

In some embodiments, a ring based interconnect unit 912 is used to couple the internal components of the processor 900. However, an alternative interconnect unit may be used, such as a point-to-point interconnect, a switched interconnect, or other techniques, including techniques well known in the art. In some embodiments, graphics processor 908 couples with the ring interconnect 912 via an I/O link 913.

The exemplary I/O link 913 represents at least one of multiple varieties of I/O interconnects, including an on package I/O interconnect which facilitates communication between various processor components and a high-performance embedded memory module 918, such as an eDRAM (or embedded DRAM) module. In some embodiments, each of the processor cores 902 to 902N and graphics processor 908 use embedded memory modules 918 as a shared Last Level Cache.

In some embodiments, processor cores 902A to 902N are homogenous cores executing the same instruction set architecture. In another embodiment, processor cores 902A to 902N are heterogeneous in terms of instruction set architecture (ISA), where one or more of processor cores 902A to 902N execute a first instruction set, while at least one of the other cores executes a subset of the first instruction set or a different instruction set. In one embodiment processor cores 902A to 902N are heterogeneous in terms of microarchitecture, where one or more cores having a relatively higher power consumption couple with one or more power cores having a lower power consumption. Additionally, processor 900 can be implemented on one or more chips or as an SoC integrated circuit having the illustrated components, in addition to other components.

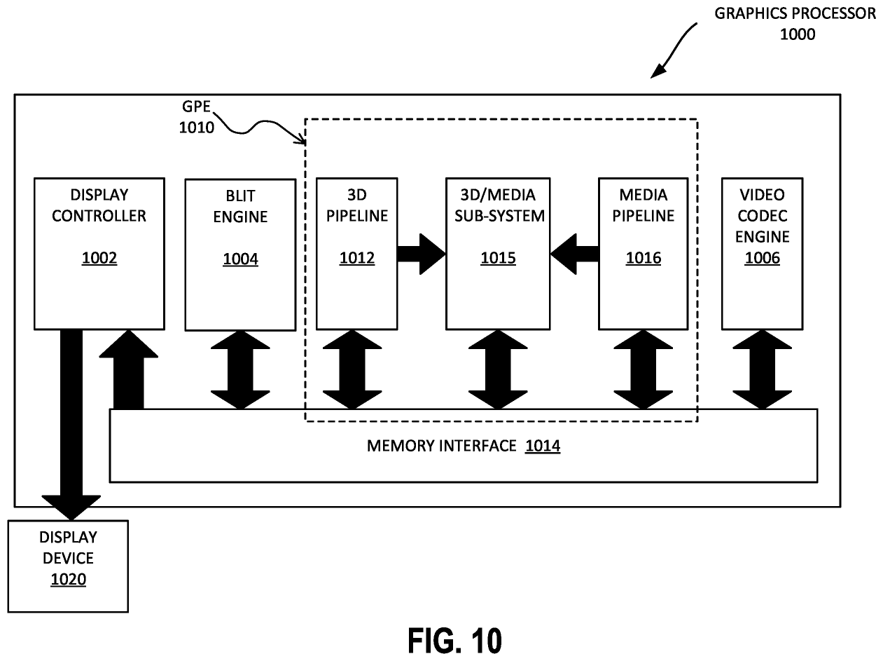

FIG. 10 is a block diagram of a graphics processor 1000, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 1000 includes a memory interface 1014 to access memory. Memory interface 1014 can be an interface to local memory, one or more internal caches, one or more shared external caches, and/or to system memory.

In some embodiments, graphics processor 1000 also includes a display controller 1002 to drive display output data to a display device 1020. Display controller 1002 includes hardware for one or more overlay planes for the display and composition of multiple layers of video or user interface elements. In some embodiments, graphics processor 1000 includes a video codec engine 1006 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 1000 includes a block image transfer (BLIT) engine 1004 to perform two-dimensional (2D) rasterizer operations including, for example, bit-boundary block transfers. However, in one embodiment, 3D graphics operations are performed using one or more components of graphics processing engine (GPE) 1010. In some embodiments, graphics processing engine 1010 is a compute engine for performing graphics operations, including three-dimensional (3D) graphics operations and media operations.

In some embodiments, GPE 1010 includes a 3D pipeline 1012 for performing 3D operations, such as rendering three-dimensional images and scenes using processing functions that act upon 3D primitive shapes (e.g., rectangle, triangle, etc.). The 3D pipeline 1012 includes programmable and fixed function elements that perform various tasks within the element and/or spawn execution threads to a 3D/Media sub-system 1015. While 3D pipeline 1012 can be used to perform media operations, an embodiment of GPE 1010 also includes a media pipeline 1016 that is specifically used to perform media operations, such as video post-processing and image enhancement.

In some embodiments, media pipeline 1016 includes fixed function or programmable logic units to perform one or more specialized media operations, such as video decode acceleration, video de-interlacing, and video encode acceleration in place of, or on behalf of video codec engine 1006. In some embodiments, media pipeline 1016 additionally includes a thread spawning unit to spawn threads for execution on 3D/Media sub-system 1015. The spawned threads perform computations for the media operations on one or more graphics execution units included in 3D/Media sub-system 1015.

In some embodiments, 3D/Media subsystem 1015 includes logic for executing threads spawned by 3D pipeline 1012 and media pipeline 1016. In one embodiment, the pipelines send thread execution requests to 3D/Media subsystem 1015, which includes thread dispatch logic for arbitrating and dispatching the various requests to available thread execution resources. The execution resources include an array of graphics execution units to process the 3D and media threads. In some embodiments, 3D/Media subsystem 1015 includes one or more internal caches for thread instructions and data. In some embodiments, the subsystem also includes shared memory, including registers and addressable memory, to share data between threads and to store output data.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes an apparatus comprising: a hardware accelerator device to advertise one or more available operations and/or capabilities of one or more work queues of the hardware accelerator device to one or more tenants; and logic circuitry, coupled to the hardware accelerator device, to control access to the one or more available operations and/or capabilities of the one or more work queues on a per-tenant basis. Example 2 includes the apparatus of example 1, wherein the hardware accelerator device is to advertise the one or more available operations and/or capabilities of the one or more work queues to the one or more tenants on a per-tenant basis. Example 3 includes the apparatus of example 1, wherein a device driver is to configure the hardware accelerator device to advertise different operations and/or capabilities of the one or more work queues on a per-tenant basis. Example 4 includes the apparatus of example 1, wherein the one or more tenants comprise one or more of: one or more virtual machines (VMs), one or more containers, and one or more applications. Example 5 includes the apparatus of example 1, wherein the hardware accelerator device is to advertise a first portion of the one or more available operations and/or capabilities of the one or more work queues to a first tenant or a first class of tenant of the one or more tenants, wherein the hardware accelerator device is to advertise a second portion of the one or more available operations and/or capabilities of the one or more work queues to a second tenant or a second class of tenants of the one or more tenants, wherein the first portion and the second portion are different portions. Example 6 includes the apparatus of example 5, further comprising a first work queue from the one or more work queues to support the first portion of the one or more available operations and/or capabilities and a second work queue from the one or more work queues to support the second portion of the one or more available operations and/or capabilities. Example 7 includes the apparatus of example 6, wherein the first work queue and the second work queue comprise an overlapping set of operations and/or capabilities. Example 8 includes the apparatus of example 6, wherein the first work queue and the second work queue comprise an overlapping set of tenants or class of tenants. Example 9 includes the apparatus of example 6, wherein the first work queue or the second work queue comprise one or more of: a dedicated work queue and a shared work queue. Example 10 includes the apparatus of example 1, further comprising one or more execution engines to execute the one or more available operations and/or execute one or more operations to support the capabilities of the one or more work queues. Example 11 includes the apparatus of example 10, wherein the hardware accelerator device comprises the one or more execution engines. Example 12 includes the apparatus of example 1, wherein the logic circuitry is to control access to the one or more available operations and/or capabilities on a per-tenant class basis. Example 13 includes the apparatus of example 1, wherein each of the one or more tenants are to pay a different price for sharing different subsets of the one or more available operations and/or capabilities of the hardware accelerator device. Example 14 includes the apparatus of example 1, wherein the one or more tenants are capable of migration between hardware accelerator devices of different generations. Example 15 includes the apparatus of example 1, wherein the logic circuitry is to control access to the one or more available operations and/or capabilities to support varying levels of system resource availability and/or quality of service for each of the one or more tenants. Example 16 includes the apparatus of example 1, wherein a processor, having one or more processor cores, comprises the hardware accelerator device and/or the logic circuitry. Example 17 includes the apparatus of example 1, wherein the logic circuitry controls access to the one or more available operations and/or capabilities on a per-tenant basis by one or more of: advertising, configuration, and enforcement. Example 18 includes the apparatus of example 1, wherein the hardware accelerator device comprises the logic circuitry.

Example 19 includes one or more non-transitory computer-readable media comprising one or more instructions that when executed on a processor configure the processor to perform one or more operations to cause: a hardware accelerator device to advertise one or more available operations and/or capabilities of one or more work queues of the hardware accelerator device to one or more tenants; and logic circuitry, coupled to the hardware accelerator device, to control access to the one or more available operations and/or capabilities of the one or more work queues on a per-tenant basis. Example 20 includes the one or more computer-readable media of example 19, further comprising one or more instructions that when executed on the at least one processor configure the at least one processor to perform one or more operations to cause the hardware accelerator device to advertise the one or more available operations and/or capabilities of the one or more work queues to the one or more tenants on a per-tenant basis. Example 21. The one or more computer-readable media of example 19, further comprising one or more instructions that when executed on the at least one processor configure the at least one processor to perform one or more operations to cause a device driver to configure the hardware accelerator device to advertise different operations and/or capabilities on a per-tenant basis.

Example 22 includes an apparatus comprising means to perform a method as set forth in any preceding example. Example 23 includes machine-readable storage including machine-readable instructions, when executed, to implement a method or realize an apparatus as set forth in any preceding example.

In various embodiments, one or more operations discussed with reference to FIGS. 1 et seq. may be performed by one or more components (interchangeably referred to herein as “logic”) discussed with reference to any of the figures.

In various embodiments, the operations discussed herein, e.g., with reference to FIGS. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a hardware accelerator device to advertise one or more available operations and/or capabilities of one or more work queues of the hardware accelerator device to one or more tenants; and
logic circuitry, coupled to the hardware accelerator device, to control access to the one or more available operations and/or capabilities of the one or more work queues on a per-tenant basis.

2. The apparatus of claim 1, wherein the hardware accelerator device is to advertise the one or more available operations and/or capabilities of the one or more work queues to the one or more tenants on a per-tenant basis.

3. The apparatus of claim 1, wherein a device driver is to configure the hardware accelerator device to advertise different operations and/or capabilities of the one or more work queues on a per-tenant basis.

4. The apparatus of claim 1, wherein the one or more tenants comprise one or more of: one or more virtual machines (VMs), one or more containers, and one or more applications.

5. The apparatus of claim 1, wherein the hardware accelerator device is to advertise a first portion of the one or more available operations and/or capabilities of the one or more work queues to a first tenant or a first class of tenant of the one or more tenants, wherein the hardware accelerator device is to advertise a second portion of the one or more available operations and/or capabilities of the one or more work queues to a second tenant or a second class of tenants of the one or more tenants, wherein the first portion and the second portion are different portions.

6. The apparatus of claim 5, further comprising a first work queue from the one or more work queues to support the first portion of the one or more available operations and/or capabilities and a second work queue from the one or more work queues to support the second portion of the one or more available operations and/or capabilities.

7. The apparatus of claim 6, wherein the first work queue and the second work queue comprise an overlapping set of operations and/or capabilities.

8. The apparatus of claim 6, wherein the first work queue and the second work queue comprise an overlapping set of tenants or class of tenants.

9. The apparatus of claim 6, wherein the first work queue or the second work queue comprise one or more of: a dedicated work queue and a shared work queue.

10. The apparatus of claim 1, further comprising one or more execution engines to execute the one or more available operations and/or execute one or more operations to support the capabilities of the one or more work queues.

11. The apparatus of claim 10, wherein the hardware accelerator device comprises the one or more execution engines.

12. The apparatus of claim 1, wherein the logic circuitry is to control access to the one or more available operations and/or capabilities on a per-tenant class basis.

13. The apparatus of claim 1, wherein each of the one or more tenants are to pay a different price for sharing different subsets of the one or more available operations and/or capabilities of the hardware accelerator device.

14. The apparatus of claim 1, wherein the one or more tenants are capable of migration between hardware accelerator devices of different generations.

15. The apparatus of claim 1, wherein the logic circuitry is to control access to the one or more available operations and/or capabilities to support varying levels of system resource availability and/or quality of service for each of the one or more tenants.

16. The apparatus of claim 1, wherein a processor, having one or more processor cores, comprises the hardware accelerator device and/or the logic circuitry.

17. The apparatus of claim 1, wherein the logic circuitry controls access to the one or more available operations and/or capabilities on a per-tenant basis by one or more of: advertising, configuration, and enforcement.

18. The apparatus of claim 1, wherein the hardware accelerator device comprises the logic circuitry.

19. One or more non-transitory computer-readable media comprising one or more instructions that when executed on a processor configure the processor to perform one or more operations to cause:
a hardware accelerator device to advertise one or more available operations and/or capabilities of one or more work queues of the hardware accelerator device to one or more tenants; and
logic circuitry, coupled to the hardware accelerator device, to control access to the one or more available operations and/or capabilities of the one or more work queues on a per-tenant basis.

20. The one or more computer-readable media of claim 19, further comprising one or more instructions that when executed on the at least one processor configure the at least one processor to perform one or more operations to cause the hardware accelerator device to advertise the one or more available operations and/or capabilities of the one or more work queues to the one or more tenants on a per-tenant basis.

21. The one or more computer-readable media of claim 19, further comprising one or more instructions that when executed on the at least one processor configure the at least one processor to perform one or more operations to cause a device driver to configure the hardware accelerator device to advertise different operations and/or capabilities on a per-tenant basis.
